(19) United States
(12) Patent Application Publication
(10) Pub. No.: US 2012/0084139 A1
(43) Pub. Date: Apr. 5, 2012

(54) SYSTEMS AND METHODS TO MATCH A REPRESENTATIVE WITH A COMMERCIAL PROPERTY BASED ON NEUROLOGICAL AND/OR PHYSIOLOGICAL RESPONSE DATA

(76) Inventors: Anantha Pradeep, Berkeley, CA (US); Ramachandran Gurumoorthy, Berkeley, CA (US); Robert T. Knight, Berkeley, CA (US)

(21) Appl. No.: 13/249,525

(22) Filed: Sep. 30, 2011

Related U.S. Application Data
(60) Provisional application No. 61/389,069, filed on Oct. 1, 2010.

(51) Int. Cl. G06Q 30/02

(52) U.S. Cl. 705/14.41; 705/14.72

(57) ABSTRACT

Example methods, systems and tangible machine readable instructions to match a representative with a commercial property are disclosed herein. An example method for matching a representative with a commercial property includes comparing one or more of neurological or physiological response data from a panelist exposed to the property or a facsimile of the property to a plurality of representative attributes to determine a plurality of compatibility scores. Each of the representative attributes corresponds to a respective candidate representative. The example method also includes selecting the candidate representative having a highest one of the compatibility scores to represent the property.

### RELATED APPLICATION

This patent claims the benefit of U.S. Provisional Patent Application Ser. No. 61/389,069, entitled “Neurological Matching System,” which was filed on Oct. 1, 2010, and which is incorporated herein by reference in its entirety.

### FIELD OF THE DISCLOSURE

This disclosure relates generally to advertising, and, more particularly, to systems and methods to match a representative with a commercial property based on neurological and/or physiological response data.

### BACKGROUND

Spokespersons for brands, commercial properties or the like are sometimes matched or selected based on characteristics or associative criteria (e.g., Michael Jordan advertising for General Mill's Wheaties cereal or Nike's gym shoes). In other cases, such matching is based on popularity or following.

### BRIEF DESCRIPTION OF THE DRAWINGS

FIG. 1 is a schematic illustration of an example system constructed in accordance with the teachings of this disclosure to match a representative with a commercial property based on neurological and/or physiological response data.

FIG. 2 shows example attribute profiles.

FIG. 3 is a flow chart representative of example machine readable instructions that may be executed to implements the example system of FIG. 1.

FIG. 4 illustrates an example processor platform that may execute the instructions of FIG. 3 to implement any or all of the example methods, systems and/or apparatus disclosed herein.

### DETAILED DESCRIPTION

Example systems and methods to match a representative with a commercial property (e.g., a brand and/or commercial article such as a product) based on neurological and/or physiological response data are disclosed. Example commercial property includes physical items (such as a product) and non-physical services and/or property (e.g., intellectual property such as, for example, a brand, a product packaging, an advertisement, a logo, a jingle, a trailer, etc.). Example representatives include, for example, a spokesperson, a model, a channel, an event, a publication, an endorsement, etc. In some examples, reaction to one or more properties) and/or one or more representative(s) are neurologically and/or physiologically assessed and a respective property attribute profile and/or a representative attribute profile are generated. One or more entries or values in the property attribute profile and/or the representative attribute profile are compared to match the property with a representative. In some examples, a property (e.g., a brand) is matched to a representative (e.g., a spokesperson) that underscores, amplifies and/or enhances the recognition of strengths of the property while obscuring, masking, aiding or diminishing recognition of weaknesses. In some examples, a property and a representative are matched by evaluating a property essence framework. As used herein a property essence framework is a strategy that analyzes multiple characteristics of a property such as, for example, form, function, feelings, values, benefits, metaphors, sentiments, extensions, etc. to determine an image or essence of a property and/or an effectiveness of one or more attribute(s) of a property. In some examples, the efficacy of an existing property/representative match is analyzed to re-assess, optimize, re-position and/or redesign the matching engagement between the property and the representative.

In some example system(s), a property and a plurality of candidate representatives are analyzed to determine which representative should be selected to best represent the property. For example, one or more subject(s) or panelist(s) are exposed to a property such as, for example, a product, a service and/or a brand of a product and/or service, via for example, a physical specimen of a product bearing the brand, a facsimile of the brand such as, for example, in an advertisement and/or any other suitable mode of communication. As used herein the term “panelist” means a person who has agreed to be monitored and/or interviewed by a measurement company. The panelist may be statistically selected to represent population(s) of interest. Thus, a panelist may have his or her neurological and/or physiological responses to a property and/or representative measured and/or be questioned in a survey. In this example, the panelist(s) are monitored during the exposure to the product, the service and/or the brand to collect neurological and/or physiological property data reflective of the reaction(s) and/or impression(s) of the panelist(s) to the product, the service and/or the brand. The collected property data is analyzed to determine the reaction(s) and/or impression(s) the panelist(s) exhibit during exposure to the product, the service and/or the brand. For example, a determination that the panelist(s) were alert, attentive and/or engaged during exposure to the product, the service and/or the brand may be indicative that the panelist(s) (individually or collectively) feel that the product, the service and/or the brand is memorable and/or have a positive reaction(s) to the product, the service and/or the brand. Alternatively, a determination that the panelist(s) were disengaged and unfocused during the exposure to the product, the service and/or the brand may be indicative that the panelist(s) (individually or collectively) feel that the product, the service and/or the brand is not memorable and/or have a negative reaction(s) to the product, the service and/or the brand. In some examples, the same and/or different panelist(s) are also exposed to a plurality of candidate representatives such as, for example, spokespersons, who potentially may be selected to represent the product, the service and/or the brand. In this example, the panelist(s) are monitored during the exposure to the spokespersons to collect neurological and/or physiological spokesperson data reflective of the reaction(s) and/or impression(s) of the panelist(s) to the spokespersons. Example reaction(s) and/or impression(s) include, for example, determinations that the panelist(s) found the spokespersons memorable or forgettable.

In some examples, the collected property data and/or results of the analysis of the panelist's reaction(s) and/or impression(s) of the product, the service and/or the brand is compared with the spokesperson data and/or results of the analysis of the panelist's reaction(s) and/or impression(s) of each of the spokespersons and compatibility scores are determined. The compatibility scores are determined based on testing criteria. For example, where a test is defined to identify a spokesperson who would complement a negative attribute of a brand, a highly memorable spokesperson may receive a higher compatibility score for a relatively unremarkable brand than a less memorable spokesperson. The example matching system selects the highly memorable spokesperson to represent the brand so that the spokesperson can bolster the brand's low memorability attribute. In other examples, a testing criterion may be defined to match a brand with a spokesperson that share common attributes. For example, a brand that is highly perceived as “cool” as reflected in the collected neurological and/or physiological data is matched with a spokesperson who also is highly perceived as “cool” as reflected in the collected neurological and/or physiological data to reinforce the brand's essence or image.

In some example such as, for example, some of the example(s) noted above, attribute(s) of a property and/or representative are originally developed or generated based on the collected neurological and/or physiological response data. Additionally or alternatively, in some example(s), the attributes of a representative and/or property are provided by an external entity including, for example, a producer of the property, an owner of the property, an agent of the representative and/or any other source to establish an image the external entity desires for the property and/or representative. In such examples, the provided attributes may be corroborated with neurological and/or physiological data. For example a spokesperson's and/or model's agent may indicate that their client's image includes particular attributes and that they will only represent properties that align with those attributes. Examples disclosed herein may test for properties to match the stated attributes of the spokesperson and/or model. In addition, examples disclosed herein may be used to confirm if panelist(s) feel that the spokesperson and/or model has the stated attributes.

In some examples, one or more panelist(s) are exposed to media showing a selected representative representing a property. For example, the panelist(s) may be exposed to an advertisement showing a selected spokesperson endorsing a brand and/or a particular product. In this example, the panelist(s) are monitored to collect post-election neurological and/or physiological response data. The data is analyzed to determine the reaction(s) and/or impression(s) of the panelist(s). This information may be used to determine if the spokesperson was effective in representing the property. For example, if the testing criteria were to match a highly memorable spokesperson with an unremarkable brand, the reaction(s) and/or impression(s) of the panelist(s) during post-election exposure to media showing the selected spokesperson representing the brand would be analyzed to determine if the memorability attribute of the brand increased. In examples in which the memorability factor did not increase, examples disclosed herein may match another, different spokesperson with the property. In examples in which the memorability factor increased, the property-spokesperson alignment is accepted and may be tested for effectiveness one or more times at some point in the future, periodically or aperiodically.

Example method(s) for matching a representative with a commercial property disclosed herein include comparing one or more of neurological or physiological response data from a panelist exposed to the property or a facsimile of the property to a plurality of representative attributes to determine a plurality of compatibility scores. In the example method(s), each of the representative attributes corresponds to a respective candidate representative. The example method(s) also include selecting the candidate representative having a highest one of the compatibility scores to represent the property.

In some examples, a property is at least one of a product, a brand, a logo, a jingle or an advertisement. Also, in some example method(s), a selected representative is at least one of a spokesperson, an event, a location, a network or a publication.

In some examples, neurological and/or physiological response data includes one or more of functional magnetic resonance imaging (fMRI) data, electroencephalography (EEG) data, galvanic skin response (GSR) data, magnetoencephalography (MEG) data, electrooculography (EOG) data, electrocardiogram (EKG) data, pupillary dilation data, eye tracking data, facial emotion encoding data or reaction time data. Also, in some examples, neurological and/or physiological response data is indicative of one or more of alertness, engagement, attention or resonance.

Some example method(s) include generating property attributes by combining neurological and/or physiological response data with at least one of target demographic data, target ethnographic data, target psychographic data, target purchase data, target market performance data or target brand vision data. Some example method(s) also include blending property attributes with panelist attributes (e.g., attributes related to the panelist or test panelist). Also, in some example method(s), panelist attributes include at least one of panelist demographic data, shopping preferences, entertainment preferences or financial data.

Some example method(s) include comparing a first property attribute with a first representative attribute for a plurality of representatives to determine a first compatibility score for each representative and comparing a second property attribute with a second representative attribute for the plurality of representatives to determine a second compatibility score for each representative. The example method(s) also include determining a composite score from the first compatibility score and the second compatibility score for each representative and selecting the candidate representative having a highest one of the composite scores to represent the property.

Some example method(s) include collecting post-election neurological and/or physiological response data associated with a medium in which a representative represents a property and determining an effectiveness of the representative in representing the property based on the post-election neurological and/or physiological response data. As used herein, “post-election” is defined to refer to a time after a representative has been selected to represent a property. In some examples, effectiveness is a function of one or more of alertness, engagement, attention or resonance as reflected by post-election neurological and/or physiological response data.

Example system(s) to match a representative with a commercial property disclosed herein include an analyzer to compare neurological and/or physiological response data from a panelist exposed to the property or a facsimile of the property to a plurality of representative attributes to determine a plurality of compatibility scores. In some such example system(s), each of the representative attributes corresponds to a respective candidate representative. The example system(s) also include a selector to select the candidate representative having a highest one of the compatibility scores to represent the property.

Some example system(s) include a generator to generate property attributes by combining neurological and/or physiological response data with at least one of target demographic data, target ethnographic data, target psychographic data, target purchase data, target market performance data or target brand vision data. In some example system(s), a generator is to blend property attributes with panelist attributes. In some example system(s), panelist attributes include at least one of demographic data, shopping preferences, entertainment preferences or financial data.

In some example system(s) an analyzer is to compare a first property attribute with a first representative attribute for a plurality of representatives to determine a first compatibility score for each representative and to compare a second property attribute with a second representative attribute for the plurality of representatives to determine a second compatibility score for each representative. The example analyzer also is to determine a composite score from the first compatibility score and the second compatibility score for each representative. In the example system(s), a selector is to select the candidate representative having a highest one of the composite scores to represent the property.

Some example system(s) include one or more sensor(s) to collect post-election neurological and/or physiological response data associated with a medium in which a representative represents a property. In some example system(s), an analyzer is to determine an effectiveness of a representative in representing a property based on the post-election neurological and/or physiological response data. In some example system(s), effectiveness is a function of one or more of alertness, engagement, attention or resonance as reflected by post-election neurological and/or physiological response data.

Example machine readable media disclosed herein store instructions thereon which, when executed, cause a machine to at least compare neurological and/or physiological response data from a panelist exposed to a commercial property or a facsimile of the property to a plurality of representative attributes to determine a plurality of compatibility scores. In some examples, each of the representative attributes corresponds to a respective candidate representative to represent the property. Also, some example instructions cause a machine to select the candidate representative having a highest one of the compatibility scores as a recommended spokesperson to represent the property.

Some example instructions cause a machine to generate property attributes by combining neurological and/or physiological response data with at least one of target demographic data, target ethnographic data, target psychographic data, target purchase data, target market performance data or target brand vision data. Also, some example instructions cause a machine to blend property attributes with panelist attributes.

Some example instructions cause a machine to compare a first property attribute with a first representative attribute for a plurality of representatives to determine a first compatibility score for each representative and to compare a second property attribute with a second representative attribute for the plurality of representatives to determine a second compatibility score for each representative. Some example instructions also cause a machine to determine a composite score from the first compatibility score and the second compatibility score for each representative and select the candidate representative having a highest one of the composite scores.

Some example instructions also cause a machine to collect post-election neurological and/or physiological response data associated with a medium in which a representative represents a property and determine an effectiveness of the representative in representing the property based on the post-election neurological and/or physiological response data.

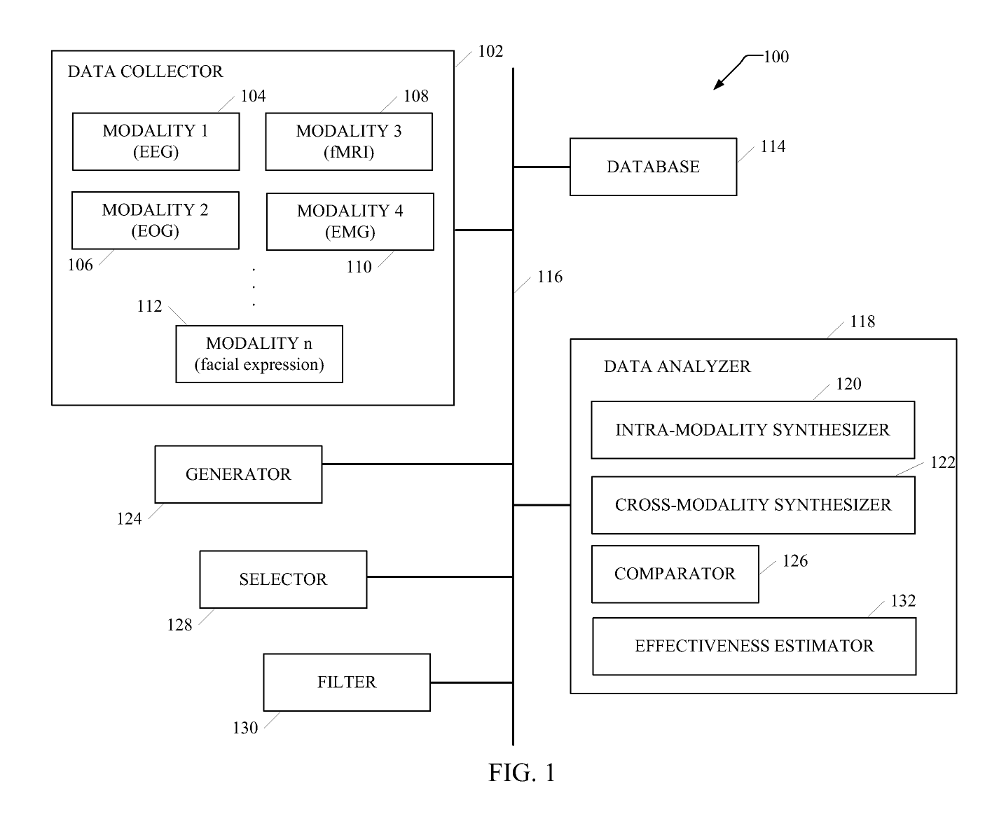

Turning to the figures, FIG. 1 illustrates an example system 100 that may be used to match a representative (e.g., a spokesperson, an event, a network and/or a publication) with a property (e.g., a product, a service, a brand, a logo, a jingle and/or an advertisement). The collected data of the illustrated example is analyzed to determine a property's attributes and/or a representative's attributes. Property attributes and/or representative attributes may be based on, for example, an assessment of one or more panelist's neurological and/or physiological reaction(s) to or impression(s) of the property and/or representative for one or more characteristics indicative of the property's and/or the representative's image or essence including, for example, form, function, feelings, value, benefits, metaphors, sentiments and/or extensions. The information about the panelist's reaction(s) and/or impression(s) may be used to select a representative to represent a property. Thus, the example system 100 facilitates property and/or representative attributes extraction and property/representative matching.

The example system 100 of FIG. 1 includes a data collector 102. In some examples the data collector 102 includes one or more sensor(s) 104, 108, 106, 110, 112 to gather one or more of user neurological data or user physiological data. The sensor(s) 104, 108, 106, 110, 112 may include, for example, one or more electrode(s), camera(s) and/or other sensor(s) to gather any type of neurological and/or physiological data (including, for example, fMRI data, EEG data, MEG data and/or optical imaging data). The sensor(s) 104, 108, 106, 110, 112 may gather data continuously, periodically or aperiodically.

The data collector 102 of the illustrated example gathers neurological and/or physiological measurements such as, for example, central nervous system measurements, autonomic nervous system measurement and/or effector measurements, which may be used to evaluate a panelist's reaction(s) and/or impression(s) of one or more properties and/or representatives. Some examples of central nervous system measurement mechanisms that are employed in some examples detailed herein include fMRI, EEG, MEG and optical imaging. Optical imaging may be used to measure the absorption or scattering of light related to concentration of chemicals in the brain or neurons associated with neuronal firing. MEG measures magnetic fields produced by electrical activity in the brain. fMRI measures blood oxygenation in the brain that correlates with increased neural activity.

EEG measures electrical activity resulting from thousands of simultaneous neural processes associated with different portions of the brain. EEG also measures electrical activity associated with post synaptic currents occurring in the milliseconds range. Subcranial EEG can measure electrical activity with high accuracy. Although bone and dermal layers of a human head tend to weaken transmission of a wide range of frequencies, surface EEG provides a wealth of useful electrophysiological information. In addition, portable EEG with dry electrodes also provides a large amount of useful neuro-response information.

EEG data can be classified in various bands. Brainwave frequencies include delta, theta, alpha, beta, and gamma frequency ranges. Delta waves are classified as those less than 4 Hz and are prominent during deep sleep. Theta waves have frequencies between 3.5 to 7.5 Hz and are associated with memories, attention, emotions, and sensations. Theta waves are typically prominent during states of internal focus. Alpha frequencies reside between 7.5 and 13 Hz and typically peak around 10 Hz. Alpha waves are prominent during states of relaxation. Beta waves have a frequency range between 14 and 30 Hz. Beta waves are prominent during states of motor control, long range synchronization between brain areas, analytical problem solving, judgment, and decision making. Gamma waves occur between 30 and 60 Hz and are involved in binding of different populations of neurons together into a network for the purpose of carrying out a certain cognitive or motor function, as well as in attention and memory. Because the skull and dermal layers attenuate waves in this frequency range, brain waves above 75-80 Hz may be difficult to detect. Nonetheless, in some of the disclosed examples, high gamma band (kappa-band: above 60 Hz) measurements are analyzed, in addition to theta, alpha, beta, and low gamma band measurements to determine a panelist's reaction(s) and/or impression(s) (such as, for example, attention, emotional engagement and memory). In some examples, high gamma waves (kappa-band) above 80 Hz (detectable with sub-cranial EEG and/or magnetoencephalography) are used in inverse model-based enhancement of the frequency responses indicative of a panelist's reaction(s) and/or impression(s). Also, in some examples, user and task specific signature sub-bands (i.e., a subset of the frequencies in a particular band) in the theta, alpha, beta, gamma and/or kappa bands are identified to estimate a panelist's reaction(s) and/or impression(s). Particular sub-bands within each frequency range have particular prominence during certain activities. In some examples, multiple sub-bands within the different bands are selected while remaining frequencies are band pass filtered. In some examples, multiple sub-band responses are enhanced, while the remaining frequency responses may be attenuated.

Autonomic nervous system measurement mechanisms that are employed in some examples disclosed herein include electrocardiograms (EKG) and pupillary dilation, etc. Effector measurement mechanisms that are employed in some examples disclosed herein include electrooculography (EOG), eye tracking, facial emotion encoding, reaction time, etc. Also, in some examples, the data collector 102 collects other type(s) of central nervous system data, autonomic nervous system data, effector data and/or other neuro-response data. The example collected neuro-response data may be indicative of one or more of alertness, engagement, attention and/or resonance.

In the illustrated example, the data collector 102 collects neurological and/or physiological data from multiple sources and/or modalities. In the illustrated, the data collector 102 includes components to gather EEG data 104 (e.g., scalp level electrodes), components to gather EOG data 106 (e.g., shielded electrodes), components to gather fMRI data 108 (e.g., a differential measurement system, components to gather EMG data 110 to measure facial muscular movement (e.g., shielded electrodes placed at specific locations on the face) and components to gather facial expression data 112 (e.g., a video analyzer). The data collector 102 also may include one or more additional sensor(s) to gather data related to any other modality described in herein including, for example, GSR data, MEG data, EKG data, pupillary dilation data, eye tracking data, facial emotion encoding data and/or reaction time data.

In some examples, only a single data collector 102 is used. In other examples a plurality of data collectors 102 are used. Data collection is performed automatically in this example. In addition, in some examples, the data collected is digitally sampled and stored for later analysis such as, for example, in the database 114. In some examples, the data collected is analyzed in real-time. According to some examples, the digital sampling rates are adaptively chosen based on the type(s) of physiological, neurophysiological and/or neurological data being measured.

In the example system 100 of FIG. 1, the data collector 102 is communicatively coupled to other components of the example system 100 via communication links 116. The communication links 116 may be any type of wired (e.g., a databus, a USB connection, etc.) or wireless communication mechanism (e.g., radio frequency, infrared, etc.) using any past, present or future communication protocol (e.g., Bluetooth, USB 2.0, etc.). Also, the components of the example system 100 may be integrated in one device or distributed over two or more devices.

The illustrated example system 100 includes an analyzer 118. The example analyzer 118 receives the data gathered from the data collector 102 and analyzes the data for trends, patterns and/or relationships. The analyzer 118 of the illustrated example reviews data within a particular modality (e.g., EEG data) and between two or more modalities (e.g., EEG data and eye tracking data). Thus, the analyzer 118 illustrated example provides an assessment of intra-modality measurements (via, for example, an intra-modality synthesizer 120) and cross-modality measurements (via, for example, a cross-modality synthesizer 122).

With respect to intra-modality measurement enhancements, in some examples, brain activity is measured to determine regions of activity and to determine interactions and/or types of interactions between various brain regions. Interactions between brain regions support orchestrated and organized behavior. Attention, emotion, memory, and other abilities are not based on one part of the brain but instead rely on network interactions between brain regions. In addition, different frequency bands used for multi-regional communication may be indicative of a panelist's reaction(s) and/or impression(s) (e.g., a level of alertness, attentiveness and/or engagement). Thus, data collection using an individual collection modality such as, for example, EEG is enhanced by collecting data representing neural region communication pathways (e.g., between different brain regions). Such data may be used to draw reliable conclusions of a panelist's reaction(s) and/or impression(s) (e.g., engagement level, alertness level, etc.) and, thus, to provide the bases for categorizing an attribute of a property and/or representative. For example, if a user's EEG data shows high theta band activity at the same time as high gamma band activity, both of which are indicative of memory activity, an estimation may be made that the panelist's reaction(s) and/or impression(s) is one of alertness, attentiveness and engagement. In response, a memory/resonance attribute of a property and/or representative may be classified “high.”

With respect to cross-modality measurement enhancements, in some examples, multiple modalities to measure biometric, neurological and/or physiological data is used including, for example, EEG, GSR, EKG, pupillary dilation, EOG, eye tracking, facial emotion encoding, reaction time and/or other suitable biometric, neurological and/or physiological data. Thus, data collected using two or more data collection modalities may be combined and/or analyzed together to draw reliable conclusions on user states (e.g., engagement level, attention level, etc.). For example, activity in some modalities occur in sequence, simultaneously and/or in some relation with activity in other modalities. Thus, information from one modality may be used to enhance or corroborate data from another modality. For example, an EEG response will often occur hundreds of milliseconds before a facial emotion measurement changes. Thus, a facial emotion encoding measurement may be used to enhance an EEG emotional engagement measure. Also, in some examples EOG and eye tracking are enhanced by measuring the presence of lambda waves (a neurophysiological index of saccade effectiveness) in the EEG data in the occipital and extra striate regions of the brain, triggered by the slope of saccade-onset to estimate the significance of the EOG and eye tracking measures. In some examples, specific EEG signatures of activity such as slow potential shifts and measures of coherence in time-frequency responses at the Frontal Eye Field (FEF) regions of the brain that preceded saccade-onset are measured to enhance the effectiveness of the saccadic activity data. Some such cross modality analyses employ a synthesis and/or analytical blending of central nervous system, autonomic nervous system and/or effector signatures. Data synthesis and/or analysis by mechanisms such as, for example, time and/or phase shifting, correlating and/or validating intra-modal determinations with data collection from other data collection modalities allow for the generation of a composite output characterizing the significance of various data responses and, thus, the classification of attributes of a property and/or representative based on a panelist's reaction(s) and/or impression(s).

According to some examples, actual expressed responses (e.g., survey data) and/or actions for one or more panelist(s) or group(s) of panelists may be integrated with biometric, neurological and/or physiological data and stored in the database or repository 114 in connection with one or more of a property and/or a representative. In some examples, the actual expressed responses may include, for example, a panelist's stated reaction and/or impression and/or demographic and/or preference information such as an age, a gender, an income level, a location, interests, buying preferences, hobbies and/or any other relevant information. The actual expressed responses may be combined with the neurological and/or physiological data to verify the accuracy of the neurological and/or physiological data, to adjust the neurological and/or physiological data and/or to generate attribute data. For example, a panelist may provide a survey response in which details of a property (e.g., a brand) are recounted. The survey response can be used to validate neurological and/or physiological response data that indicated that the panelist was engaged and memory retention activity was high.

In the illustrated example, the system 100 includes a generator 124. The example generator 124 blends data from the data collector 102, the analyzer 118 and/or the database 114 to generate attribute data and/or criteria for use in matching a property with a representative. For example, the generator 124 generates property attributes by combining neurological and/or physiological response data of a panelist's reaction(s) and/or impression(s) when exposed to a property with property owner data related to the property including, for example, target and/or historical demographic data, target and/or historical ethnographic data, target and/or historical psychographic data, target and/or historical purchase data, target and/or historical market performance data and/or target and/or historical brand vision data of a property based on past objectives, present expectations and/or future plans for the property. In some examples, the generator 124 blends the property attributes with panelist attributes, where the panelist attributes include, for example panelist demographic data, shopping preferences, entertainment preferences and/or financial data.

In some examples, the analyzer 118 classifies the data from, for example, the data collector 102, the database 114, the intra-modality synthesizer 120, the cross-modality synthesizer 122 and/or the generator 124 using one or more classification guidelines. For example, data may be classified in accordance with taxonomical categorization, dimensional classifications, product or service consumption or sales information, general attributes, core perception attributes, consumer response attributes by region, consumer response attributes by channel, consumer response attributes by demography and/or in accordance with the property essence framework disclosed above as related to multiple characteristics of the property such as, for example, form, function, feelings, values, benefits, metaphors, sentiments and/or extensions. The example analyzer 118 may tag or otherwise associate each property and/or representative with details of its respective classification using, for example, metadata tags.

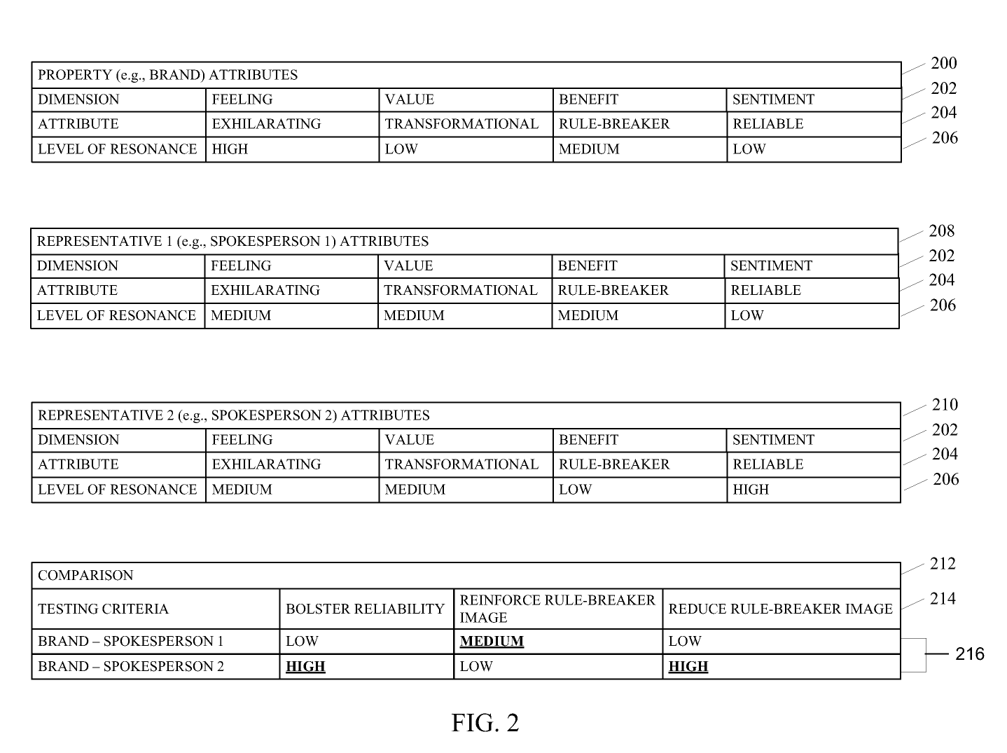

In addition, the example analyzer 118 may assign ratings for each property and/or each representative in the database 114 across one or more of the characteristics. The ratings may be quantitative (e.g., a number along a scale such as “2 of 5”), qualitative (e.g., “high” or “low”) and/or a combination of quantitative and qualitative (e.g., “2 of 5, low”). An example attribute profile of a property (e.g., a brand) and multiple representatives (e.g., two spokespersons) is shown in FIG. 2 and discussed below.

The example generator 124 of FIG. 1 also blends the attributes (property, representative, panelist and/or other attributes disclosed herein) to generate criteria for matching a property with a representative. For example, when the property is a brand, the example system 100 may use neuro-physiological assessments of attention, emotion, memory, persuasion, novelty, awareness, effectiveness of the brand, brand message, brand vision, brand position, brand campaign and/or subconscious resonance to key attributes as characteristics to analyze or evaluate when matching a property with a representative. Some example criteria that may be established for matching a property and a representative may be, for example, to match strengths, to shore up weaknesses and/or to provide a lead into aspiration segments, demographics and/or markets.

In some examples, the analyzer 118 includes a comparator 126 that matches a representative with a commercial property. The example comparator 126 compares neuro-response data from one or more panelist(s) exposed to the property or a facsimile of the property to a plurality of representative attributes to determine a plurality of compatibility scores. The neuro-response data from the panelist may include, for example, data from the data collector 102, the database 114, the intra-modality synthesizer 120, the cross-modality synthesizer 122 and/or the generator 124. In some examples, the representative attributes are based on data associated with respective candidate representatives that was gathered from panelist's neurological and/or physiological responses as measured by the sensor(s) 104, 106, 108 110, 112 noted above. The attributes also may be defined by an entity related to the property, defined by an agent of the representative and/or otherwise incorporated into the example system 100.

The example compatibility scores are an assessment of how well a property and a representative are compatible based on the classifications assigned by the analyzer 118 and/or the criteria (e.g., testing criteria) defined by the generator 124. In some examples, multiple attributes are compared. Each comparison is associated with a compatibility score, and the individual compatibility scores are summed to determine a composite score. The composite score provides an overall assessment of how well a property and a representative are compatible over multiple attributes.

The example analyzer 118 and/or the example generator 124 may employ one or more techniques, standards and/or algorithms for classifying the data, blending the attributes, generating the matching/testing criteria and/or conducting the comparison. Example techniques that may be employed by the generator 124 include hierarchical Bayesian models, fuzzy logic based decision making and/or other algorithms to blend, for example, multi-granular, multi-quality attributes and/or dimensions into one or more blending criteria. In addition, clustering analysis that determines salient groups based on attribute clustering and/or identifies meta-attribute and/or blending criteria may also be employed. Also, in some examples, multi-dimensional, multi-cost function based optimization to extract best fit and/or match is used.

The example system 100 of FIG. 1 also includes a selector 128. The example selector 128 selects one of a plurality of candidate representatives to represent the property. The selector 128, in this example, may select the representative having a highest one of the compatibility scores or a highest one of the composite scores. In other examples, the selector 128 may select other representatives based on criteria specific to that selections process.

The example system 100 also includes a filter 130 that filters the collected data to remove noise, artifacts, and/or other irrelevant data using any or all of fixed and/or adaptive filtering, weighted averaging, advanced component extraction (like PCA, ICA), vector and/or component separation methods, etc. The filter 130 cleanses the data by removing both exogenous noise (where the source is outside the physiology of the panelist, e.g., a phone ringing while a panelist is viewing a video) and endogenous artifacts (where the source could be neurophysiological, e.g., muscle movements, eye blinks, etc.).

The example filter 130 also includes mechanisms to selectively isolate and review the data and/or identify epochs with time domain and/or frequency domain attributes that correspond to artifacts such as line frequency, eye blinks, and/or muscle movements. The filter 130 cleanses the artifacts by either omitting these epochs, or by replacing these epoch data with an estimate based on the other clean data (for example, an EEG nearest neighbor weighted averaging approach).

In some examples, the data collector 102 collects post-election neurological and/or physiological response data associated with a medium (e.g., an advertisement) in which the selected representative represents the property. In some examples, the analyzer 118 includes an effectiveness estimator 132 that determines an effectiveness of a representative in representing a property based on the post-election neurological and/or physiological response data. In some examples, effectiveness is a function of one or more of alertness, engagement, attention or resonance as reflected by the post-election neurological and/or physiological response data. Thus, for example the effectiveness estimator 132 analyzes the data to determine an effectiveness of a representative in representing a property by determining if the representation has produced a desired result in changing or maintaining a desired user reaction(s) and/or impression(s) of the property. Such a determination may be made by, for example, comparing survey results, neurological data and/or physiological data collected from panelists before the representative to similar results and/or data collected after the representative.

In some examples, effectiveness is correlated with resonance. In such examples, the effectiveness estimator 132 analyzes the post-election data and assesses and extracts resonance patterns. In some examples, the effectiveness estimator 132 determines property and/or representative positions in various media and matches position information with eye tracking paths while correlating saccades with neural assessments of attention, memory retention, and emotional engagement.

FIG. 2 shows a plurality of example attribute models or profiles. A first attribute profile 200 shows property attributes, which, in this example, are brand attributes. The example property attributes profile 200 details the criteria and classification used to organize, assess and compare the property and one or more representatives. In this example, the example property attributes profile 200 provides information showing multiple dimensions 202 that are analyzed. In this example, the dimensions of feeling, value, benefit and sentiment are analyzed. In other examples, any dimension indicative of an essence and/or image of a property may be used. The example property attributes profile 200 lists an attribute 204 of the property that is to be studied and/or matched for each of the dimensions. For example, the brand that is the panelist of the property attributes profile 200 will be studied and/or matched based on whether it is “exhilarating” in the feeling dimension, “transformational” in the value dimension, “rule-breaker” in the benefit dimension and/or “reliable” in the sentiment dimension. The example property attributes profile 200 also provides classifications 206 for the attributes. In this example, the classifications 206 are based on a level of resonance. In other examples, the classification may be based on a level of effectiveness, a level of attention, a level of emotion engagement, a memory and/or any other desired category. In this example, a panelist's or a group of panelists' neurological and/or physiological response data (e.g., reaction(s) and/or impression(s)), when assessed, indicated that the example brand is rated or classified as “High” for a feeling of exhilaration. The brand is also rated as “Low” for the panelist's/panelists' neurological and/or physiological response to whether the brand is a revolutionary or transformational brand. The example brand is rated as “Medium” for the panelist's/panelists' neurological and/or physiological response to whether the brand has a rule-breaker image. In addition, the example brand has a rating of “Low” for the panelist's/panelists' neurological and/or physiological response to whether the sentiment of the brand is that the brand is reliable.

FIG. 2 also illustrates a first representative attribute profile 208 and a second representative attribute profile 210. The first and second representative attribute profiles 208, 210 in this example correspond to first and second candidate spokespersons, respectively. However, either or both of the profiles 208, 210 could alternatively relate to an event, a periodical, a television chow, a movie, etc. The first and second representative attribute profiles 208, 210 provide information related to the same dimensions 202, attributes 204 and classification category 206 to facilitate comparison of information contained in the first and second representative attribute profiles 208, 210 with the property profile 200. In other examples, there may be more or less and/or different dimensions 202, attributes 204 and/or classification categories 206 for any property and/or representative profile provided.

In some examples, the property profile 200 is compared with both the first spokesperson profile 208 and the second spokesperson profile 210 to determine which spokesperson (i.e., represented by corresponding ones of the first and second representative attribute profiles 208, 210) best matches the brand. An example comparison 212 is shown in FIG. 2. In this example, the testing criterion 214 was established to determine the best match to bolster a sentiment of reliability. In this example, the property profile 200 indicates that the property (e.g., brand) suffers from a low reliability sentiment. Spokesperson 1 also suffers from a low reliability sentiment. Thus, a compatibility score 216 between the property (e.g., brand) and Spokesperson 1 is low for a resonance of a reliability sentiment. Spokesperson 2, however, has a high resonance of a reliability sentiment. Thus, a compatibility score 216 between the property (e.g., brand) and Spokesperson 2 is high. Based on a comparison of the respective compatibility scores 216 between the property (e.g., brand) and each of Spokesperson 1 and Spokesperson 2, Spokesperson 2 has a higher compatibility score 216. Thus, the selector 128, in this example, selects Spokesperson 2 to represent the property based on a resonance of a reliability sentiment because Spokesperson 2's high reliability resonance is highly compatible with the desire to increase or bolster the low reliability resonance of the property.

In another example, if the testing criterion 214 is to determine a match to enhance, increase or reinforce the image of the property (e.g., brand) as a rule breaker, then the comparator 126 may investigate the benefits column of the profiles 200, 208, 210. The property has a rule-breaker resonance of “Medium,” as does Spokesperson 1. Spokesperson 2 has a rule-breaker resonance of “Low.” If the desired result of, for example, an advertising campaign, is to ensure that the property maintains a mid-level rule-breaker resonance or does not decrease the property's image as a rule-breaker, then Spokesperson 1 would have a higher compatibility score 216 with the property than Spokesperson 2, and the selector 128 would select Spokesperson 1 to represent the property. However, if the testing criterion 214 indicates a desired result is to purify or reduce the property's real-breaker image, Spokesperson 2 would have a higher compatibility score 216 with the property than Spokesperson 1, and the selector 128 would select Spokesperson 2 to represent the property. The above examples can be reversed if the focus is on adjusting the attributes of the spokesperson.

While example manners of implementing the example system 100 to match a representative with a property have been illustrated in FIG. 1, one or more of the elements, processes and/or devices illustrated in FIG. 1 may be combined, divided, re-arranged, omitted, eliminated and/or implemented in any other way. Further, the example data collector 102, the example sensors 104, 106, 108, 110, 112, the example database 114, the example data analyzer 118, the example intra-modality synthesizer 120, the example cross-modality synthesizer 122, the example generator 124, the example comparator 126, the example selector 128, the example filter 130 and/or the example effectiveness estimator 132 and/or, more generally, the example system 100 of FIG. 1 may be implemented by hardware, software, firmware and/or any combination of hardware, software and/or firmware. Thus, for example, the example data collector 102, the example sensors 104, 106, 108, 110, 112, the example database 114, the example data analyzer 118, the example intra-modality synthesizer 120, the example cross-modality synthesizer 122, the example generator 124, the example comparator 126, the example selector 128, the example filter 130 and/or the example effectiveness estimator 132 and/or, more generally, the example system 100 of FIG. 1 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus or system claims are read to cover a purely software and/or firmware implementation, at least one of the example data collector 102, the example sensors 104, 106, 108, 110, 112, the example database 114, the example data analyzer 118, the example intra-modality synthesizer 120, the example cross-modality synthesizer 122, the example generator 124, the example comparator 126, the example selector 128, the example filter 130 and/or the example effectiveness estimator 132 are hereby expressly defined to include a tangible computer readable medium such as a memory, DVD, CD, etc. storing the software and/or firmware. Further still, the example system 100 of FIG. 1 may include one or more elements, processes and/or devices in addition to, or instead of, those illustrated in FIG. 1, and/or may include more than one of any or all of the illustrated elements, processes and devices.

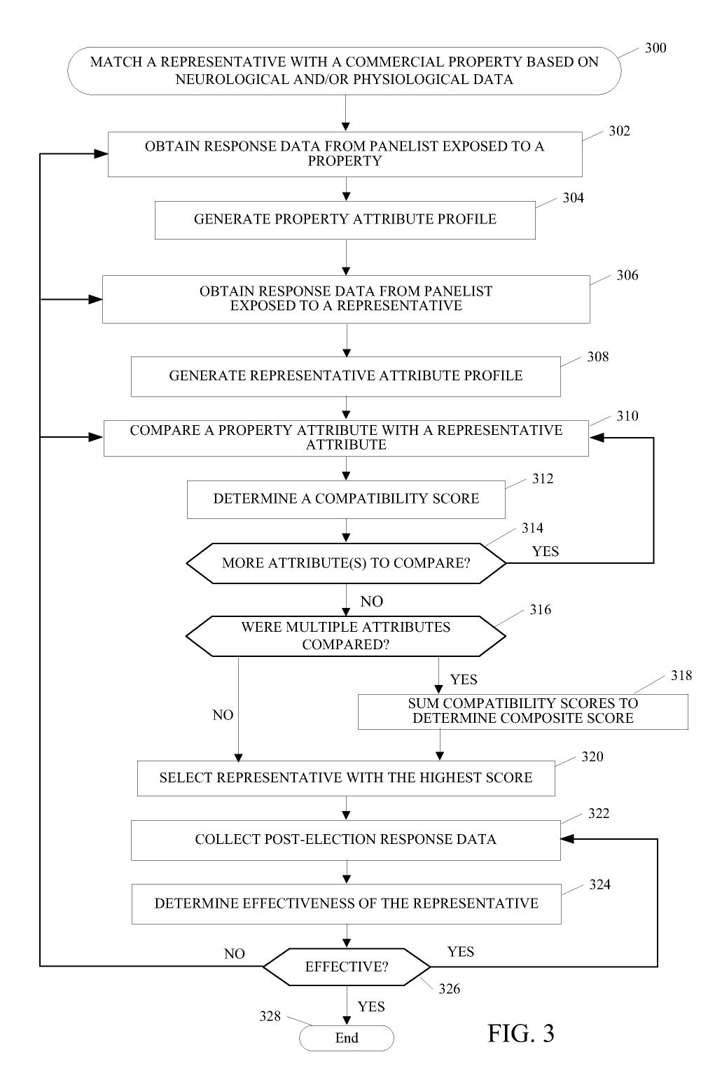

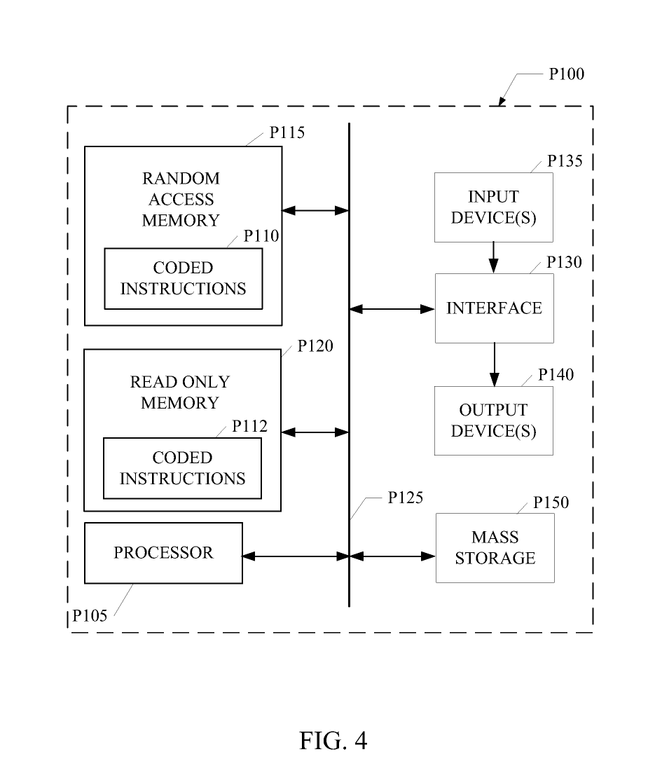

FIG. 3 is a flowchart representative of example machine readable instructions that may be executed to implement the example system 100, the example data collector 102, the example sensors 104, 106, 108, 110, 112, the example database 114, the example data analyzer 118, the example intra-modality synthesizer 120, the example cross-modality synthesizer 122, the example generator 124, the example comparator 126, the example selector 128, the example filter 130, the example effectiveness estimator 132 and other components of FIG. 1. In the examples of FIG. 3, the machine readable instructions include a program for execution by a processor such as the processor P105 shown in the example computer P100 discussed below in connection with FIG. 4. The program may be embodied in software stored on a computer readable medium such as a CD-ROM, a floppy disk, a hard drive, a digital versatile disk (DVD), or a memory associated with the processor P105, but the entire program and/or parts thereof could alternatively be executed by a device other than the processor P105 and/or embodied in firmware or dedicated hardware. Further, although the example program is described with reference to the flowchart illustrated in FIG. 3, many other methods of implementing the example system 100, the example data collector 102, the example sensors 104, 106, 108, 110, 112, the example database 114, the example data analyzer 118, the example intra-modality synthesizer 120, the example cross-modality synthesizer 122, the example generator 124, the example comparator 126, the example selector 128, the example filter 130, the example effectiveness estimator 132 and other components of FIG. 1 may alternatively be used. For example, the order of execution of the blocks may be changed, and/or some of the blocks described may be changed, eliminated, or combined.

As mentioned above, the example processes of FIG. 3 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIG. 3 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

FIG. 3 illustrates an example process to match a representative with a commercial property based on neurological and/or physiological data (block 300). The example process 300 includes obtaining neurological and/or physiological data from a panelist exposed to a property (block 302). In some examples, the data is obtained by monitoring and collecting data through a sensor such as, for example the sensor 104, 106, 108, 110, 112 of the data collector 102. In some examples, the data is generated based on raw data. Also, in some examples, the data is provided by an entity associated with the property and, thus, is not obtained from the panelist. The example method 300 including generating a property attribute profile (block 304). The property attribute profile (e.g., the property attribute profile 200 of FIG. 2) may include one or more of the dimensions, attributes, classifications, categories and/or data disclosed above.

The example method 300 also includes obtaining neurological and/or physiological data from a panelist exposed to a representative (block 306). In some examples, the data is obtained by monitoring and collecting data through a sensor such as, for example the sensor 104, 106, 108, 110, 112 of the data collector 102. In some examples, the data is generated based on raw data. Also, in some examples, the data is provided by an entity associated with the representative (e.g., an agent, a producer, etc.) and, thus, is not obtained from the panelist. The example method 300 including generating a representative profile (block 308). The representative attribute profile (e.g., the first and second representative attribute profiles 208, 210 of FIG. 2) may include one or more of the dimensions, attributes, classifications, categories and/or data disclosed above.

The example method 300 of FIG. 3 includes comparing a property attribute with a representative attribute (block 310) to determine a compatibility score between the compared property attribute and representative attribute (block 312) such as, for example, the example comparison 212 and example compatibility scores 216 of FIG. 2. The example method also determines if another property attribute and/or representative attribute is to be compared (block 314). If one or more attribute(s) are yet to be compared, the method 300 returns control to block 310 and the additional one or more attribute(s) are compared. If there are not more attributes to compare (block 314), the example method 300 determines if multiple attributes were compared (block 316). If multiple attributes were compared, the example method 300 sums the compatibility scores for the compared attributes and determines a composite score (block 318). The example method 300 then selected the representative with the highest score (e.g., composite score) (block 320). In examples in which multiple attributes were not compared (block 316), i.e., only one attribute was compared, the representative with the highest score (e.g., compatibility score) will be selected (block 320) to represent the property.

The method 300 may continue, for example, by collecting post-election neurological and/or physiological response data (block 322) by, for example, monitoring and collecting data through a sensor such as, for example the sensor 104, 106, 108, 110, 112 of the data collector 102. With the post-election data, the method 300 determines an effectiveness of the selected representative (block 324) in representing the property and producing a desired result such as, for example, with the effectiveness estimator 132, described above. If the selected representative is not effective (block 326), the control may return to obtain further data related to the property (block 302), to obtain further data related to one or more representatives (block 306) and/or to compare one or more property attribute(s) with one or more representative attributes (block 310) and the process 300 may continue to select another representative. If, however, the first selected representative is effective (block 326), the example process 300 may end (block 328) or the example process 300 continue to collect post-election data (block 322) to continue to monitor the effectiveness of the representative (block 324).

FIG. 4 is a block diagram of an example processing platform P100 capable of executing the instructions of FIG. 3 to implement the example system 100, the example data collector 102, the example sensors 104, 106, 108, 110, 112, the example database 114, the example data analyzer 118, the example intra-modality synthesizer 120, the example cross-modality synthesizer 122, the example generator 124, the example comparator 126, the example selector 128, the example filter 130 and the example effectiveness estimator 132. The processor platform P100 can be, for example, a server, a personal computer, or any other type of computing device.

The processor platform P100 of the instant example includes a processor P105. For example, the processor P105 can be implemented by one or more Intel® microprocessors. Of course, other processors from other families are also appropriate.

The processor P105 is in communication with a main memory including a volatile memory P115 and a non-volatile memory P120 via a bus P125. The volatile memory P115 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory P120 may be implemented by flash memory and/or any other desired type of memory device. Access to the main memory P115, P120 is typically controlled by a memory controller.

The processor platform P100 also includes an interface circuit P130. The interface circuit P130 may be implemented by any type of past, present or future interface standard, such as an Ethernet interface, a universal serial bus (USB), and/or a PCI express interface.

One or more input devices P135 are connected to the interface circuit P130. The input device(s) P135 permit a user to enter data and commands into the processor P105. The input device(s) can be implemented by, for example, a keyboard, a mouse, a touchscreen, a track-pad, a trackball, isopoint and/or a voice recognition system.

One or more output devices P140 are also connected to the interface circuit P130. The output devices P140 can be implemented, for example, by display devices (e.g., a liquid crystal display, and/or a cathode ray tube display (CRT)). The interface circuit P130, thus, typically includes a graphics driver card.

The interface circuit P130 also includes a communication device, such as a modem or network interface card to facilitate exchange of data with external computers via a network (e.g., an Ethernet connection, a digital subscriber line (DSL), a telephone line, coaxial cable, a cellular telephone system, etc.).

The processor platform P100 also includes one or more mass storage devices P150 for storing software and data. Examples of such mass storage devices P150 include floppy disk drives, hard drive disks, compact disk drives and digital versatile disk (DVD) drives.

The coded instructions of FIG. 3 may be stored in the mass storage device P150, in the volatile memory P110, in the non-volatile memory P112, and/or on a removable storage medium such as a CD or DVD.

Although certain example methods, apparatus and properties of manufacture have been disclosed herein, the scope of coverage of this patent is not limited thereto. On the contrary, this patent covers all methods, apparatus and properties of manufacture fairly falling within the scope of the claims of this patent.

What is claimed is:

1. A method for matching a representative with a commercial property, the method comprising:
comparing one or more of neurological or physiological response data from a panelist exposed to the property or a facsimile of the property to a plurality of representative attributes to determine a plurality of compatibility scores, each of the representative attributes corresponding to a respective candidate representative; and
selecting the candidate representative having a highest one of the compatibility scores to represent the property.

2. The method of claim 1, wherein the property is at least one of a product, a brand, a logo, a jingle or an advertisement.

3. The method of claim 1, wherein the selected representative is at least one of a spokesperson, an event, a location, a network or a publication.

4. The method of claim 1, wherein the one or more of neurological or physiological response data includes one or more of fMRI data, EEG data, GSR data, MEG data, EOG data, EKG data, pupillary dilation data, eye tracking data, facial emotion encoding data or reaction time data.

5. The method of claim 1, wherein the one or more of neurological or physiological response data is indicative of one or more of alertness, engagement, attention or resonance.

6. The method of claim 1 further comprising generating property attributes by combining the one or more of neurological or physiological response data with at least one of target demographic data, target ethnographic data, target psychographic data, target purchase data, target market performance data or target brand vision data.

7. The method of claim 6 further comprising blending the property attributes with panelist attributes, wherein the panelist attributes include at least one of panelist demographic data, shopping preferences, entertainment preferences or financial data.

8. The method of claim 6 further comprising:
comparing a first property attribute with a first representative attribute for a plurality of representatives to determine a first compatibility score for each representative;
comparing a second property attribute with a second representative attribute for the plurality of representatives to determine a second compatibility score for each representative;
determining a composite score from the first compatibility score and the second compatibility score for each representative; and
selecting the candidate representative having a highest one of the composite scores to represent the property.

9. The method of claim 1 further comprising:
collecting one or more of post-election neurological or physiological response data associated with a medium in which the representative represents the property; and
determining an effectiveness of the representative in representing the property based on the one or more post-election neurological or physiological response data.

10. The method of claim 9, wherein the effectiveness is a function of one or more of alertness, engagement, attention or resonance as reflected by the one or more of post-election neurological or physiological response data.

11. A system to match a representative with a commercial property, the system comprising:
an analyzer to compare one or more of neurological or physiological response data from a panelist exposed to the property or a facsimile of the property to a plurality of representative attributes to determine a plurality of compatibility scores, each of the representative attributes corresponding to respective candidate representative; and a selector to select the candidate representative having a highest one of the compatibility scores to represent the property.

12. The system of claim 11, wherein the property is at least one of a product, a brand, a logo, a jingle or an advertisement.

13. The system of claim 11, wherein the selected representative is at least one of a spokesperson, an event, a location, a network or a publication.

14. The system of claim 11, wherein the one or more neurological or physiological response data includes one or more of fMRI data, EEG data, GSR data, MEG data, EOG data, EKG data, pupillary dilation data, eye tracking data, facial emotion encoding data or reaction time data.

15. The system of claim 11, wherein the one or more of neurological or physiological response data is indicative of one or more of alertness, engagement, attention or resonance.

16. The system of claim 11 further comprising a generator to generate property attributes by combining the one or more neurological or physiological response data with at least one of target demographic data, target ethnographic data, target psychographic data, target purchase data, target market performance data or target brand vision data.

17. The system of claim 16, wherein the generator is to blend the property attributes with panelist attributes, wherein the panelist attributes include at least one of panelist demographic data, shopping preferences, entertainment preferences or financial data.

18. The system of claim 17, wherein the analyzer is to compare a first property attribute with a first representative attribute for a plurality of representatives to determine a first compatibility score for each representative, to compare a second property attribute with a second representative attribute for the plurality of representatives to determine a second compatibility score for each representative, to determine a composite score from the first compatibility score and the second compatibility score for each representative, and the selector is to select the candidate representative having a highest one of the composite scores to represent the property.

19. The system of claim 11 further comprising a sensor to collect one or more post-election neurological or physiological response data associated with a medium in which the representative represents the property, wherein the analyzer is to determine an effectiveness of the representative in representing the property based on the one or more post-election neurological or physiological response data.

20. The system of claim 19, wherein the effectiveness is a function of one or more of alertness, engagement, attention or resonance as reflected by the one or more post-election neurological or physiological response data.

21. A tangible machine readable medium storing instructions thereon which, when executed, cause a machine to at least:
compare one or more of neurological or physiological response data from a panelist exposed to a commercial property or a facsimile of the property to a plurality of representative attributes to determine a plurality of compatibility scores, each of the representative attributes corresponding to a respective candidate representative to represent the property; and
select the candidate representative having a highest one of the compatibility scores to represent the property.

22. The machine readable medium of claim 21, wherein the property is at least one of a product, a brand, a logo, a jingle or an advertisement.

23. The machine readable medium of claim 21, wherein the selected representative is at least one of a spokesperson, an event, a location, a network or a publication.

24. The machine readable medium of claim 21, wherein the one or more of neurological or physiological response data includes one or more of fMRI data, EEG data, GSR data, MEG data, EOG data, EKG data, pupillary dilation data, eye tracking data, facial emotion encoding data or reaction time data.

25. The machine readable medium of claim 21, wherein the one or more of neurological or physiological response data is indicative of one or more of alertness, engagement, attention or resonance.

26. The machine readable medium of claim 21 further causing a machine to generate property attributes by combining the one or more neurological or physiological response data with at least one of target demographic data, target ethnographic data, target psychographic data, target purchase data, target market performance data or target brand vision data.

27. The machine readable medium of claim 26 further causing the machine to blend the property attributes with panelist attributes, wherein the panelist attributes include at least one of panelist demographic data, shopping preferences, entertainment preferences or financial data.

28. The machine readable medium of claim 26 further causing the machine to:
compare a first property attribute with a first representative attribute for a plurality of representatives to determine a first compatibility score for each representative;
compare a second property attribute with a second representative attribute for the plurality of representatives to determine a second compatibility score for each representative;
determine a composite score from the first compatibility score and the second compatibility score for each representative; and
select the candidate representative having a highest one of the composite scores to represent the property.

29. The machine readable medium of claim 21 further causing the machine to:
collect one or more post-election neurological or physiological response data associated with a medium in which the representative represents the property; and
determine an effectiveness of the representative in representing the property based on the one or more post-election neurological or physiological response data.

30. The machine readable medium of claim 21, wherein the effectiveness is a function of one or more of alertness, engagement, attention or resonance as reflected by the one or more post-election neurological or physiological response data.
